(19) United States
(12) Patent Application Publication
(10) Pub. No.: US 2019/0055168 A1
(43) Pub. Date: Feb. 21, 2019

(54) Biochar Fertilizer and Related Methods

(71) Applicant: Board of Supervisors of Louisiana State University and Agricultural and Mechanical College, Baton Rouge, LA (US)

(72) Inventors: Jim Jian Wang, Baton Rouge, LA (US); Meng Wang, Xianyang City (CN)

(21) Appl. No.: 16/104,432

(22) Filed: Aug. 17, 2018

Related U.S. Application Data
(60) Provisional application No. 62/547,345, filed on Aug. 18, 2017.

(51) Int. Cl. C05F 5/00; A01C 21/00; C10B 53/02

(52) U.S. Cl. CPC C05F 5/002; C10B 53/02; A01C 21/00

(57) ABSTRACT

Compositions including a biochar, and related methods are described herein. The composition can be produced by contacting a biomass with a pretreatment agent including an alkali metal or an alkaline earth metal to form a pretreated biomass, and pyrolyzing the pretreated biomass under conditions sufficient to form a biochar. A related method includes contacting soil with the composition thereby increasing a soluble plant available silicon content in the soil.

### CROSS-REFERENCE TO RELATED APPLICATIONS

This application claims the benefit of U.S. Provisional Application No. 62/547,345, filed Aug. 18, 2018. The patent application identified above is incorporated here by reference in its entirety.

### STATEMENT REGARDING FEDERALLY SPONSORED RESEARCH OR DEVELOPMENT

Not Applicable.

### TECHNICAL FIELD

The present disclosure relates to organic fertilizers produced from a biomass, and related methods. More specifically, the present disclosure relates to a biochar produced from a biomass contacted with a pretreatment agent, and related methods.

### BACKGROUND

This section introduces information from the art that may be related to or provide context for some aspects of the techniques described herein and/or claimed below. This information is background facilitating a better understanding of that which is disclosed herein. Such background may include a discussion of “related” art. That such art is related in no way implies that it is also “prior” art. The related art may or may not be prior art. The discussion is to be read in this light, and not as admissions of prior art.

Silicon (Si) plays an important role in disease prevention in plants, and it has been increasingly recognized as a beneficial element for plant production. Typical Si fertilizers are primarily based on mineral sources and industrial byproducts; however, such fertilizers can be limited in some manner or contain toxic heavy metals.

For example, silicon fertilizers can include wollastonite and slags. Wollastonite is considered an efficient silicon fertilizer for soil application because it can release the largest amount of plant-available silicon into soil solution for plant uptake. However, wollastonite can be limited as a result of its relatively high cost and because it is a non-renewable resource.

As another example, silica slag from industrial waste materials (e.g., blast-furnace and silicon-manganese slag from steel manufacturing, and electric furnace slag from phosphorus production) have a lower cost than the above mentioned Si fertilizers. However, such silica slags often contain a variety of heavy metals, which can cause biotic damage to plant and pollution in the environment. For example, some steel slags can have a high content of Cr (e.g., up to 1.1 wt. %), and other metals (e.g., 43 wt. % of Fe, 26 wt. % of Mg, and 46 wt. % of Mn). Therefore, there is a need for improved methods, devices, and systems for the production of stable and/or beneficial silicon fertilizers.

Contained herein is a disclosure directed to resolving, or at least reducing, one or more of the problems mentioned above, or other problems that may exist in the art.

### NON-LIMITING BRIEF SUMMARY OF THE INVENTION

The present disclosure relates to compositions comprising a biochar, and related methods. The composition in one aspect comprises a biochar characterized in that it has at least the following characteristics: a pH in the range of about 8 to about 11, based on a biochar to deionized water ratio of 1:100; a total potassium content in the range of about 13.31 g/kg to about 378.33 g/kg, as measured by inductively coupled emission spectrometry; and a soluble plant available silicon content in the range of about 0.75 wt. % to about 6.0 wt. %, based on total weight of the composition containing the biochar, wherein the soluble plant available silicon content is determined by 5-day Na₂CO₃—NH₄NO₃ extraction.

In one or more aspects of the invention, the composition comprises a biochar characterized in that it has at least the following characteristics: a pH in the range of about 9.5 to about 10.5, based on a biochar to deionized water ratio of 1:100; a total potassium content in the range of about 79.77 g/kg to about 183.78 g/kg, as measured by inductively coupled emission spectrometry; and a soluble plant available silicon content in the range of about 0.75 wt. % to about 6.0 wt. %, based on total weight of the composition containing the biochar, wherein the soluble plant available silicon content is determined by 5-day Na₂CO₃—NH₄NO₃ extraction.

Another aspect of the invention provides a method comprising contacting a biomass with a pretreatment agent comprising an alkali metal or an alkaline earth metal to form a pretreated biomass; and pyrolyzing the pretreated biomass under conditions sufficient to form a biochar.

One or more aspects of the invention include the method of the preceding paragraph wherein the pretreatment agent to biomass ratio is from 1:100 to 50:100, on a weight basis.

One or more aspects of the invention include the method of any preceding paragraph wherein the pretreatment agent to biomass ratio is 10:100.

One or more aspects of the invention include the method of any preceding paragraph wherein the pyrolyzing step is carried out at a temperature in the range of about 350° C. to about 600° C.

One or more aspects of the invention include the method of any preceding paragraph further comprising dehydrating the pretreated biomass.

One or more aspects of the invention include the method of any preceding paragraph wherein the dehydrating step is carried out at a temperature in the range of 150° C. to about 180° C.

One or more aspects of the invention include the method of any preceding paragraph wherein the pretreatment agent comprises at least one selected from the group consisting of potassium, calcium, and any combination thereof.

One or more aspects of the invention include the method of any preceding paragraph wherein the pretreatment agent comprises at least one selected from the group consisting of potassium hydroxide, potassium carbonate, and any combination thereof.

One or more aspects of the invention include the method of any preceding paragraph wherein the pretreatment agent comprises calcium oxide.

One or more aspects of the invention include the method of any preceding paragraph wherein the biomass comprises one or more materials selected from the group consisting of rice straw, rice husk, sugar cane harvest residue, miscanthus, and switch grass.

One or more aspects of the invention include the method of any preceding paragraph wherein the biomass comprises at least one selected from the group consisting of rice straw, rice husk, and any combination thereof.

One or more aspects of the invention include the method of any preceding paragraph wherein the pretreatment agent comprises calcium oxide.

One or more aspects of the invention include the method of any preceding paragraph wherein the pretreatment agent comprises at least one selected from the group consisting of potassium hydroxide, potassium carbonate, and any combination thereof.

Another aspect of the invention includes a method comprising contacting soil with the composition comprising a biochar according to any preceding paragraph or a composition comprising a biochar prepared by any preceding paragraph, thereby increasing a soluble plant available silicon content in the soil.

Another aspect of the invention includes a composition comprising a biochar prepared by any preceding paragraph.

While multiple embodiments are disclosed, still other embodiments will become apparent to those skilled in the art from the following detailed description. As will be apparent, certain embodiments, as disclosed herein, are capable of modifications in various obvious aspects, all without departing from the spirit and scope of the claims as presented herein. Accordingly, the drawings and detailed description are to be regarded as illustrative in nature and not restrictive.

### BRIEF DESCRIPTION OF THE SEVERAL VIEWS OF THE DRAWINGS

This patent or application file contains at least one drawing executed in color. Copies of this patent or patent application publication with color drawing(s) will be provided by the USPTO upon request and payment of the necessary fee.

The claimed subject matter may be understood by reference to the following description taken in conjunction with the accompanying figures, in which like reference numerals identify like elements, and in which:

FIG. 1A illustrates a chart of total silicon content in biomass feedstocks and biochar produced from biomass feed stocks contacted with potassium hydroxide, as determined by HF—HCl, for rice straw, wherein the symbols on the chart have the following meanings: Feedstock (FS); Biochar made from Feedstock (0 KB); 0 KB, 1 KB, 5 KB, 10 KB, 25 KB, and 50 KB indicate the biochars prepared at the proportion of KOH to feedstock of 0, 1, 5, 10, 25, and 50 per 100 part of feedstock on weight basis, respectively. The lower case letters of a, b, c, d, e in the graph indicate a statistically significant difference between the treatments at 5% level (α=0.05).

FIG. 1B illustrates a chart of total silicon content in biomass feedstocks and biochar produced from biomass feed stocks contacted with potassium hydroxide, as determined by HF—HCl, for miscanthus, wherein the symbols on the chart have the following meanings: Feedstock (FS); Biochar made from Feedstock (0 KB); 0 KB, 1 KB, 5 KB, 10 KB, 25 KB, and 50 KB indicate the biochars prepared at the proportion of KOH to feedstock of 0, 1, 5, 10, 25, and 50 per 100 part of feedstock on weight basis, respectively. The lower case letters of a, b, c, d, e in the graph indicates a statistically significant difference between the treatments at 5% level (α=0.05).

FIG. 1C illustrates a chart of total silicon content in biomass feedstocks and biochar produced from biomass feed stocks contacted with potassium hydroxide, as determined by HF—HCl, for sugarcane harvest residue, wherein the symbols on the chart have the following meanings: Feedstock (FS); Biochar made from Feedstock (0 KB); 0 KB, 1 KB, 5 KB, 10 KB, 25 KB, and 50 KB indicate the biochars prepared at the proportion of KOH to feedstock of 0, 1, 5, 10, 25, and 50 per 100 part of feedstock on weight basis, respectively. The lower case letters of a, b, c, d in the graph indicates a statistically significant difference between the treatments at 5% level (α=0.05).

FIG. 1D illustrates a chart of total silicon content in biomass feedstocks and biochar produced from biomass feed stocks contacted with potassium hydroxide, as determined by HF—HCl, for switchgrass, wherein the symbols on the chart have the following meanings: Feedstock (FS); Biochar made from Feedstock (0 KB); 0 KB, 1 KB, 5 KB, 10 KB, 25 KB, and 50 KB indicate the biochars prepared at the proportion of KOH to feedstock of 0, 1, 5, 10, 25, and 50 per 100 part of feedstock on weight basis, respectively. The lower case letters of a, b, c, d in the graph indicates a statistically significant difference between the treatments at 5% level (α=0.05).

FIG. 2A illustrates a chart of plant available silicon content in biomass feedstocks and biochar produced from biomass feed stocks contacted with potassium hydroxide, as determined by 5-day Na₂CO₃—NH₄NO₃ extraction, for rice straw, wherein the symbols on the chart have the following meanings: wollastonite (WO); Feedstock (FS); Biochar made from Feedstock (0 KB); 0 KB, 1 KB, 5 KB, 10 KB, 25 KB, and 50 KB indicate the biochars prepared at the proportion of KOH to feedstock of 0, 1, 5, 10, 25, and 50 per 100 part of feedstock on weight basis, respectively. The different lower letters of a, b, c, d, e in the graph indicates a statistically significant difference between the treatments at 5% level (α=0.05).

FIG. 2B illustrates a chart of plant available silicon content in biomass feedstocks and biochar produced from biomass feed stocks contacted with potassium hydroxide, as determined by 5-day Na₂CO₃—NH₄NO₃ extraction, for miscanthus, wherein the symbols on the chart have the following meanings: wollastonite (WO); Feedstock (FS); Biochar made from Feedstock (0 KB); 0 KB, 1 KB, 5 KB, 10 KB, 25 KB, and 50 KB indicate the biochars prepared at the proportion of KOH to feedstock of 0, 1, 5, 10, 25, and 50 per 100 part of feedstock on weight basis, respectively. The different lower letters of a, b, c, d, e in the graph indicates a statistically significant difference between the treatments at 5% level (α=0.05).

FIG. 2C illustrates a chart of plant available silicon content in biomass feedstocks and biochar produced from biomass feed stocks contacted with potassium hydroxide, as determined by 5-day Na₂CO₃—NH₄NO₃ extraction, for sugarcane harvest residue, wherein the symbols on the chart have the following meanings: wollastonite (WO); Feedstock (FS); Biochar made from Feedstock (0 KB); 0 KB, 1 KB, 5 KB, 10 KB, 25 KB, and 50 KB indicate the biochars prepared at the proportion of KOH to feedstock of 0, 1, 5, 10, 25, and 50 per 100 part of feedstock on weight basis, respectively. The lower case letters of a, b, c, d, e in the graph indicates a statistically significant difference between the treatments at 5% level (α=0.05).

FIG. 2D illustrates a chart of plant available silicon content in biomass feedstocks and biochar produced from biomass feed stocks contacted with potassium hydroxide, as determined by 5-day Na₂CO₃—NH₄NO₃ extraction, for switchgrass, wherein the symbols on the chart have the following meanings wollastonite (WO); Feedstock (FS); Biochar made from Feedstock (0 KB); 0 KB, 1 KB, 5 KB, 10 KB, 25 KB, and 50 KB indicate the biochars prepared at the proportion of KOH to feedstock of 0, 1, 5, 10, 25, and 50 per 100 part of feedstock on weight basis, respectively. The different low case letters of a, b, c, d, e in the graph indicates statistically significant difference between the treatments at 5% level (α=0.05).

FIG. 3 illustrates scanning electron microscope (SEM) images and individual element mapping of rice straw A=Feedstock (FS); B=0 KB; and C=10 KB.

FIG. 4A illustrates plant available silicon content in incubation of amendments and application rates of Commerce and Briley soils, as determined by sodium acetate extraction, for rice straw, wherein the symbols on the chart have the following meanings: wollastonite (WO); Feedstock (FS); Biochar made from Feedstock (0 KB); 0 KB, 5 KB, 10 KB, and 25 KB are biochars prepared with the proportion of KOH to feedstock of 0, 5, 10, and 25 per 100 part of feedstock on weight basis, respectively. The lower case letters of a, b, c, d, e in the graph indicates a statistically significant difference between the treatments at 5% level (α=0.05).

FIG. 4B illustrates plant available silicon content in incubation of amendments and application rates of Commerce and Briley soils, as determined by sodium acetate extraction, for miscanthus, wherein the symbols on the chart have the following meanings: wollastonite (WO); Feedstock (FS); Biochar made from Feedstock (0 KB); 0 KB, 5 KB, 10 KB, and 25 KB are biochars prepared with the proportion of KOH to feedstock of 0, 5, 10, and 25 per 100 part of feedstock on weight basis, respectively. The lower case letters of a, b, c, d in the graph indicates a statistically significant difference between the treatments at 5% level (α=0.05).

FIG. 4C illustrates plant available silicon content in incubation of amendments and application rates of Commerce and Briley soils, as determined by sodium acetate extraction, sugarcane harvest residue at day 8, wherein the symbols on the chart have the following meanings: wollastonite (WO); Feedstock (FS); Biochar made from Feedstock (0 KB); 0 KB, 5 KB, 10 KB, and 25 KB are biochars prepared with the proportion of KOH to feedstock of 0, 5, 10, and 25 per 100 part of feedstock on weight basis, respectively. The lower case letters of a, b, c, d, e in the graph indicates a statistically significant difference between the treatments at 5% level (α=0.05).

FIG. 5A illustrates a chart of plant available silicon content in rice straw and biochar produced from rice straw contacted with K₂CO₃ pretreatment, as determined by 5-day Na₂CO₃—NH₄NO₃ extraction, wherein the symbols on the chart have the following meanings: Feedstock (FS); Biochar made from Feedstock (0K2B); 0K2B, 1K2B, 5K2B, 10K2B, 25K2B, and 50K2B indicate the biochars prepared at the proportion of K₂CO₃ to feedstock of 0, 1, 5, 10, 25, and 50 per 100 part of feedstock on weight basis, respectively.

FIG. 5B illustrates a chart of plant available silicon content in rice straw and biochar produced from rice straw contacted with CaO pretreatment, as determined by 5-day Na₂CO₃—NH₄NO₃ extraction, wherein the symbols on the chart have the following meanings: Feedstock (FS); Biochar made from Feedstock (0 KB); 0 CB, 1 CB, 5 CB, 10 CB, 25 CB, and 50 CB indicate the biochars prepared at the proportion of CaO to feedstock of 0, 1, 5, 10, 25, and 50 per 100 part of feedstock on weight basis, respectively.

FIG. 6 illustrates a chart of plant available silicon results of pretreatment of rice husk biomass with KOH. Plant available silicon is determined by 5-day Na₂CO₃—NH₄NO₃ extraction, wherein the symbols on the chart have the following meanings Biochar made from Feedstock (0 KB); 0 KB, 5 KB, and 10 KB, indicate the biochars prepared at the proportion of KOH to feedstock of 0, 5, and 10 per 100 part of feedstock on weight basis, respectively.

The accompanying drawings illustrate specific embodiments. However, it is to be understood that these embodiments are not intended to be exhaustive, nor limiting of the disclosure. These specific embodiments are but examples of some of the forms in which the disclosure may be practiced. Like reference numbers or symbols employed across the several figures are employed to refer to like parts or components illustrated therein.

### DETAILED DESCRIPTION

Disclosed herein are compositions comprising a biochar, and related methods.

### 1. FORMATION OF A BIOCHAR FROM A PRETREATED BIOMASS

A method for producing the composition comprises contacting a biomass with a pretreatment agent comprising an alkali metal or an alkaline earth metal to form a pretreated biomass, and pyrolyzing the pretreated biomass under conditions sufficient to form a biochar.

The biomass can be selected from a variety of sources, for example, an organic material, such as plant material, cellulosic materials, lignin containing material, agricultural waste, other naturally derived sources of carbon, or any combination thereof. In one or more embodiments, the biomass is selected based on the chemical content of the biomass, the elemental composition of the biomass, or the content of its elemental composition. As an example, the biomass can be selected based on the silicon content of the biomass. Higher the silicon content in the biomass can be indicative of a higher content of plant soluble plant available silicon content in the biochar. Agricultural plants and waste residue such as rice straw (RS), rice husk, and sugarcane harvest residues contain considerable amounts of silicon (e.g., about 3 wt. % to about 30 wt. %, based on total weight of biomass). Other agricultural plants and residues such as miscanthus (M) and switchgrass contain high amounts of silicon (e.g., 1.7 wt. % to 2.0 wt. %, based on total weight of biomass). Thus, in one or more embodiments, the biomass comprises one or more materials selected from the group consisting of rice straw, rice husk, sugar cane harvest residue, miscanthus, switch grass, and any combination thereof. As shown in the examples below, biochar produced from rice straw and/or rice husk exhibits superior results as compared to other biomass materials. In other embodiments, the biomass comprises at least one material selected from the group consisting of rice straw, rice husk, and any combination thereof.

The biomass is contacted with a pretreatment agent capable of increasing, among other things, a soluble plant available silicon content in the composition produced by the methods described herein as compared to a biomass that is not contacted with a pretreatment agent. In one or more embodiments, the pretreatment agent comprises an alkali metal or an alkaline earth metal such as a compound comprising at least one selected form the group consisting of potassium, calcium, and any combination thereof. For example, the pretreatment agent can be at least one compound selected from the group consisting of potassium hydroxide, potassium carbonate, calcium oxide, and any combination thereof. In one or more embodiments, the pretreatment agent to biomass ratio (pretreatment agent:biomass) may be from about 1:100 to about 50:100, based on total weight of biomass. The pretreatment agent to biomass ratio (i.e., pretreatment agent:biomass) may be from about 5:100 to about 50:100, based on weight. The pretreatment agent to biomass ratio (i.e., pretreatment agent:biomass) may be from about 10:100 to about 25:100. The pretreatment agent to biomass ratio (i.e., pretreatment agent:biomass) may be about 5:100, 10:100, 25:100, or 50:100, based on weight.

In one or more embodiments, the particle size and shape of the biomass can be controlled by cutting, crushing, grinding, milling, screening, or breaking of a biomass material. For example, the biomass can be screened to a certain size fraction or range of size fractions. In one or more embodiments, prior to contact with the pretreatment agent, the biomass can have a particle size of less than or equal to about 5 mm, and more preferably less than or equal to about 1 mm.

The pyrolyzing step can be carried out using a pyrolysis unit (e.g., a furnace, gasifier or reactor), which can be operated in a batch, continuous, or semi-continuous mode. The pyrolyzing step is carried out in the pyrolysis unit operated under predetermined conditions sufficient to form one or more selected biochar products. For example, the pyrolysis unit can be controlled such that a biomass feedstock is heated at a specific rate to a desired. The pyrolyzing step can be conducted at a temperature in the range of about 350° C. to about 600° C. for a time period in the range from about 60 minutes to about 90 minutes, more preferably at a temperature in the range of about 500° C. about 550° C. for about 60 minutes. A shorter time period is generally used with temperatures at the higher end of the range, and a longer time period is generally used with temperatures at the lower end of the range (e.g, about 350° C. for 90 about minutes, and about 600° C. for about 60 minutes).

In one or more embodiments, the method further comprises dehydrating the pretreated biomass at a temperature in the range of about 150° C. to about 180° C. for about 30 min, followed by pyrolyzing step. The dehydration step can make the pyrolysis step more efficient, for example, enhancing carbonation at a reduced time.

### 2. COMPOSITION

In another aspect, the invention includes a composition comprising a biochar. In one or more embodiments, the biochar is characterized in that the biochar has at least the following characteristics: a pH in the range of about 8 to about 11, based on a biochar to deionized water ratio of about 1:100; a total potassium content in the range of about 13.31 g/kg to about 378.33 g/kg, as measured by inductively coupled emission spectrometry; and a soluble plant available silicon content in the range of about 0.75 wt. % to about 6.0 wt. % or greater, or about 2.2 wt. % to about 4.75 wt. % or greater, based on total weight of the composition containing the biochar, wherein the soluble plant available silicon content is determined by 5-day Na₂CO₃—NH₄NO₃ extraction. In one or more embodiments, the biochar has at least the following characteristics: a pH in the range of about 9.5 to about 10.5, based on a biochar to deionized water ratio of 1:100; a total potassium content in the range of about 79.77 g/kg to about 183.78 g/kg, as measured by inductively coupled emission spectrometry; and a soluble plant available silicon content in the range of about 0.75% to about 6.0 wt. % or greater, or about 0.75 wt. % to about 4.75 wt. % or greater, based on total weight of the composition containing the biochar, wherein the soluble plant available silicon content is determined by 5-day Na₂CO₃—NH₄NO₃ extraction. The biochar can be prepared by any of the methods described herein.

### 3. USE OF COMPOSITION WITH SOIL

In another aspect, the invention includes a method comprising contacting soil with a composition, as described herein, thereby increasing a soluble plant available silicon content in the soil. The biochar can be used as a soil amendment, potting mix, a substitute in a growing media (including peat and/or compost media), a horticultural media, a fertilizing agent, a turfgrass establishment, a bioremediation agent, or any combination thereof.

Biochar can be applied to soils in the range of about 0.1 wt. % (i.e., about 2.25 tons per hectare) to about 3 wt. % (i.e., 67.5 tons per hectare), based on top 0 cm to about 15 cm soil weight, or in the range of about 0.1 wt. % (i.e., about 2.25 tons per hectare) to about 1.0 wt. % (i.e., 22.5 tons per hectare). Biochar is preferably incorporated into the soil at a soil depth in the range of about 1 cm to about 15 cm.

### 4. EXAMPLES

The present disclosure can be better understood by reference to the following examples, which are presented for purposes of illustration and are not intended to limit the scope of the invention.

### 4.1 Biomass and Preparation Thereof.

Five biomasses including rice straw (RS), rice husk, sugarcane harvest residue, miscanthus (M), and switchgrass (S) were collected from collected from Louisiana State University AgCenter Research Stations (Crowley, St. Gabriel, and Baton Rouge, USA, respectively). Each biomass was washed using deionized water to remove dust and dried at 60° C. for 24 hours. Each dried biomass was ground by a high-speed rotary cutting mill and passed through 1 mm sieve. To form biochar, each biomass was mixed with various quantities of potassium hydroxide to form various samples of biomass contacted with potassium hydroxide. Namely, for rice straw, sugarcane harvest residue, miscanthus and switchgrass, samples were prepared having the following potassium hydroxide to biomass ratios (KOH:biomass ratio): 0:100 (0 KB), 1:100 (1 KB), 5:100 (5 KB), 10:100 (10 KB), 25:100 (25 KB), and 50:100 (50 KB) on a weight basis in a porcelain crucible followed by equilibration with 100 mL of ultra-pure water (based on 50 g of biomass) for 90 minutes. Each crucible containing the biomass sample was then placed in muffle furnace under N₂ flow at 400 mL/min for 30 min to remove air from the system. Pyrolysis was initiated with muffle furnace temperature set at 180° C. for dehydration for 30 min followed by 550° C. for 60 min under N₂ flow rate at 200 mL/min. After pyrolysis, the resulting biochar samples were removed from the furnace after the temperature cooled down and ground to pass a 1 mm sieve before characterization.

Rice straw samples were also prepared using the same procedure in the preceding paragraph, except that the rice straw samples were contacted with K₂CO₃ or CaO instead of KOH.

Rice husk samples were also prepared using the same procedure in the preceding paragraph, except that only 3 samples were prepared having the following potassium hydroxide to biomass ratios (KOH:biomass ratio): 0:100 (0 KB), 5:100 (5 KB), and 10:100 (10 KB).

### 4.2 Biochar Characterization.

The pH of biochar samples was determined based on a biochar to deionized water ratio of 1:100. (Suliman, W., Harsh, J. B., Abu-Lail, N. I., et al., 2016. Modification of biochar surface by air oxidation: Role of pyrolysis temperature. Biomass and Bioenergy. 85, 1-11). Ash content was determined using a furnace operated at 550° C. for 5 hr. Total C, H and N content was determined using an elemental analyzer (Model Vario EL Cube, Elementar Analysen systeme GmbH, Germany). Total P, K, Ca, Mg, Al and Fe content was measured by inductively coupled plasma atomic emission spectrometry (ICP-AES, SPECTRO Plasma 3200, Germany) after samples being digested using nitric acid and H₂O₂ (Huang, C. Y. L. and Schulte, E., 1985. Digestion of plant tissue for analysis by ICP emission spectroscopy. Communications in Soil Science & Plant Analysis. 16, 943-958). In addition, the morphology and elemental distribution of biochar samples were characterized using a field emission gun scanning electron microscopy (FEG-SEM, JEOL 6335F, Japan) equipped with an energy dispersive X-ray (EDX) spectroscopy.

Silicon status in KOH-enhanced biochars and feedstocks was evaluated using 1.5 M HF-0.6 M HCl extraction for total Si and 5-day Na₂CO₃—NH₄NO₃ for fertilizer soluble Si followed by light absorption spectrometry (Sebastian, D., Rodrigues, H., Kinsey, C., et al., 2013. A 5-Day Method for Determination of Soluble Silicon Concentrations in Nonliquid Fertilizer Materials Using a Sodium Carbonate-Ammonium Nitrate Extractant Followed by Visible Spectroscopy with Heteropoly Blue Analysis Single-Laboratory Validation. Journal of AOAC International. 96, 251-259; Saito, K., Yamamoto, A., Sa, T., et al., 2005. Rapid, Micro-Methods to Estimate Plant Silicon Content by Dilute Hydrofluoric Acid Extraction and Spectrometric Molybdenum Method. Soil Science and Plant Nutrition. 51, 29-36). The HF—HCl extraction was carried out at a 1:100 solid to solution ratio for 1 h with stirring every 10 min. The 5-day Na₂CO₃—NH₄NO₃ extraction was performed at 1:100 solid to solution ratio for 1 hr shaking (140 rpm) and then allowed to stand undisturbed for 4 days and 23 hours. The latter method is the AAPFCO-approved official procedure, as described in Sebastian et al., 2013, for specifically determining plant-available Si in non-liquid fertilizers in the United States (Sebastian et al., 2013). After the extractions, the mixtures were filtered using quantitative Whatman filter paper. The Si in the filtrates was quantified by light absorption spectrometry with a SPECTRONIC 501 spectrophotometer (Thermo Scientific, Wilmington, Del.) following blue silicomolybdous acid procedures (Sebastian et al., 2013; Hallmark, C., Wilding, L. and Smeck, N., 1982. Silicon. Methods of Soil Analysis. Part 2. Chemical and Microbiological Properties. 263-273). A standard curve was prepared for calibrating the spectrometer for each extraction method before sample analysis.

### 4.3 Incubation Experiments.

The impact of KOH-enhanced biochars on soil Si status was evaluated in an incubation experiment. In doing so, biochar samples of 0 KB, 1 KB, 5 KB, 10 KB and 25 KB along with feedstocks (FS) and wollastonite (WO) were applied to two different acidic soils: Briley (pH 5.8, loamy, siliceous, semiactive, thermic Arenic Paleudults) and Commerce (pH 5.2, fine-silty, mixed, superactive, thermic Fluvaquentic Endoaquepts) at two different rates (1% and 3%), respectively. The 1% and 3% rates are on a weight basis, for example, such as 0.01 kg biochar plus 0.99 kg soil to make a 1% soil application. The incubation was maintained at 70% field water-holding capacity for 8 days. The experiments were replicated twice. During the incubation, soil pH was monitored based on 1:1 soil to deionized water ratio (Thomas, G., Sparks, D., Page, A., et al., 1996. Soil pH and soil acidity. Methods of soil analysis. Part 3-chemical methods., 475-490), and plant-available Si was determined by the commonly used soil Si test procedure based on 1 M sodium acetate extraction at 1:10 soil to solution ratio followed by light absorption spectrometry using blue silicomolybdous acid procedures (Wang, J. J., Dodla, S. K. and Henderson, R. E., 2004. Soil silicon extractability with seven selected extractants in relation to colorimetric and ICP determination. Soil science. 169, 861-870.; Sparks, D. and Bartels, J. 1996. Pt. 3: Chemical methods: Madison: Soil Science Society of America etc.).

### 4.4 Statistical Analysis.

All statistical analyses were performed using the Statistical Analysis Software, version 9.0 (SAS Institute, Cary, N.C.). Average results for the different treatments were compared using ANOVA.

### 5. RESULTS

5.1 Characteristics of Biochar Pretreated with Potassium Hydroxide (KOH).

Selected chemical and physical properties of the KOH-enhanced biochar used in this study are presented in Table 1. The pH of all raw biochar from biomass (0 KB) was between 9.52-9.63, whereas KOH pretreatments increased the pH by an additional 0.09-1.50 units. Ash content in biochars increased with KOH amendment with clear contribution from elevated potassium (K) levels, which also lead to generally increased overall biochar yields, especially at greater KOH pretreatment. On the other hand, at low levels of KOH pretreatment, biochar ash content was mainly determined by each respective biomass, with rice straw biochar (RSB) generally having the highest ash content followed by sugarcane harvest residue biochar (SHRB), miscanthus biochar (MB), and then switchgrass biochar (SB). Rice husk biochar exhibited similar results to that of rice straw biochar. Total C, H and N content of the produced biochars generally decreased with increasing ratios of KOH:Biomass, by 55-61%, 14-71% and 58-84%, respectively, depending on specific biomass. Total K content was increased by 924-2565% with increasing ratios of KOH:Biomass from 1 KB to 50 KB, whereas P, Ca, Mg, Al, and Fe content in the corresponding biochars decreased. These results showed that KOH pretreatment affected the compositions of resulting biochars besides the difference in biomass types.

5.2 Silicon Concentration of Biochars Pretreated with Potassium Hydroxide (KOH).

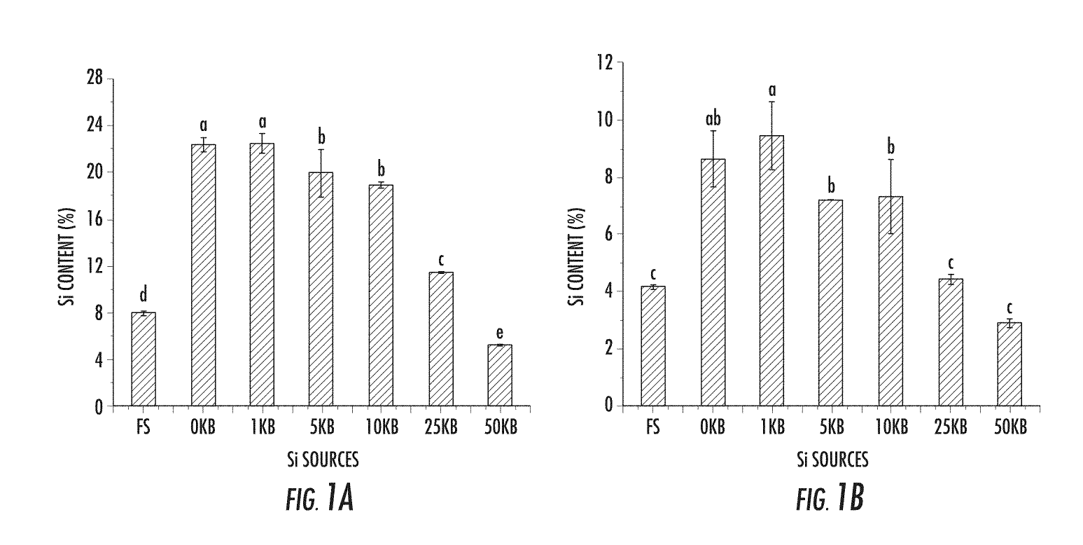

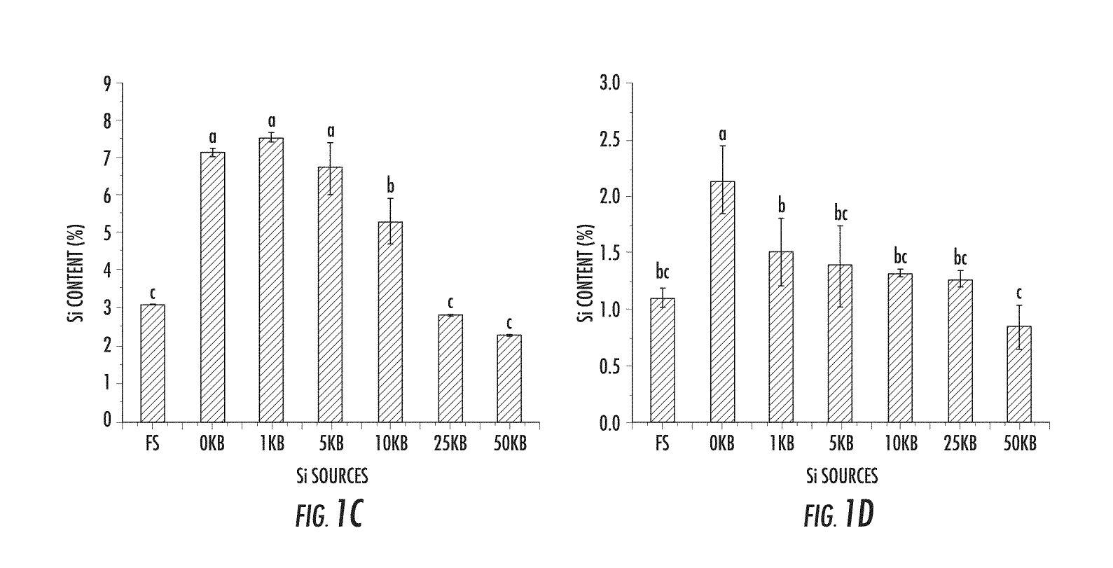

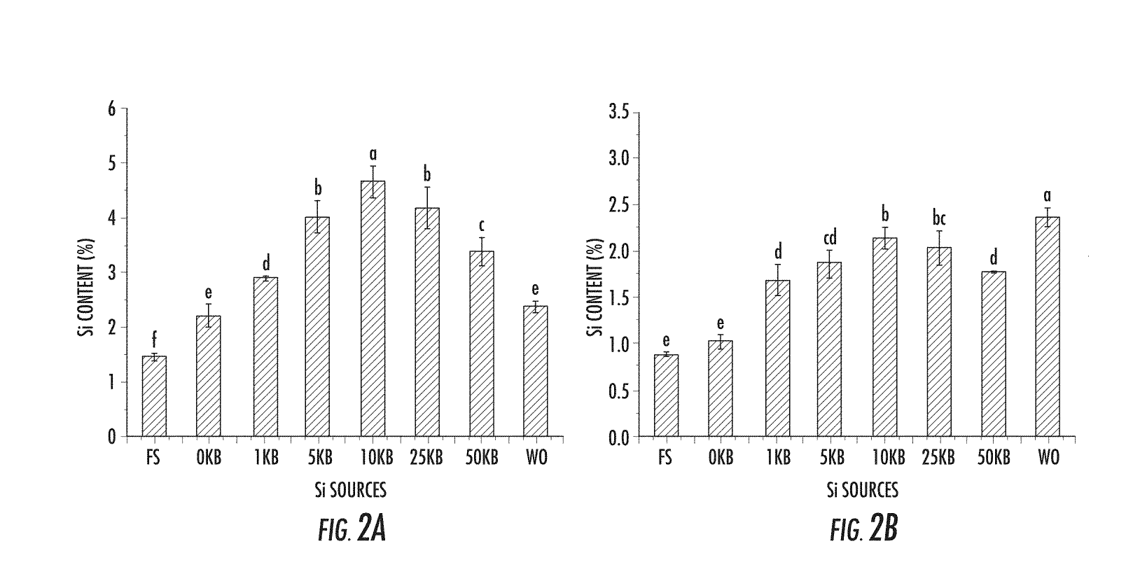

Total silicon (Si) concentrations varied with different biomasses and changed with increasing KOH treatment as illustrated in FIGS. 1A-1D. Among the five biomasses, rice straw and rice husk had the highest Si content followed by miscanthus, sugarcane harvest residue, and switchgrass. Biochar conversion significantly concentrated total Si from 7.93% to 22.45% for rice straw, 4.16% to 9.46% for miscanthus, 3.10% to 7.54% for sugarcane harvest residue, and 1.10% to 2.15% for switchgrass. The KOH pretreatment generally decreased the percentage of total Si in biochar, especially as K became a major part of biochar component for 5 KB and more, and the weight of biomass was significantly decreased as shown in Table 1.

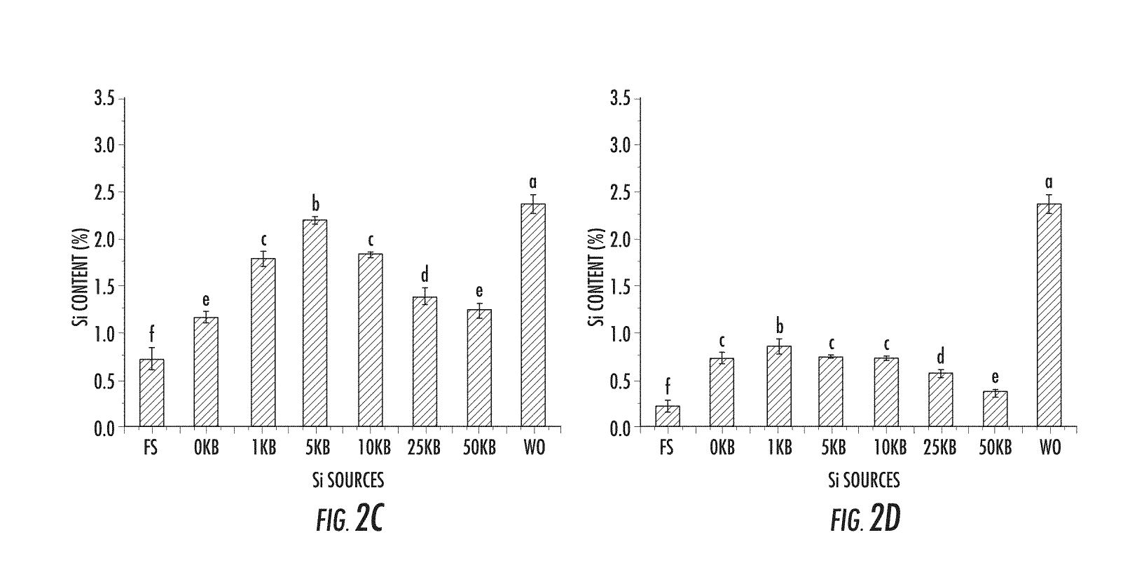

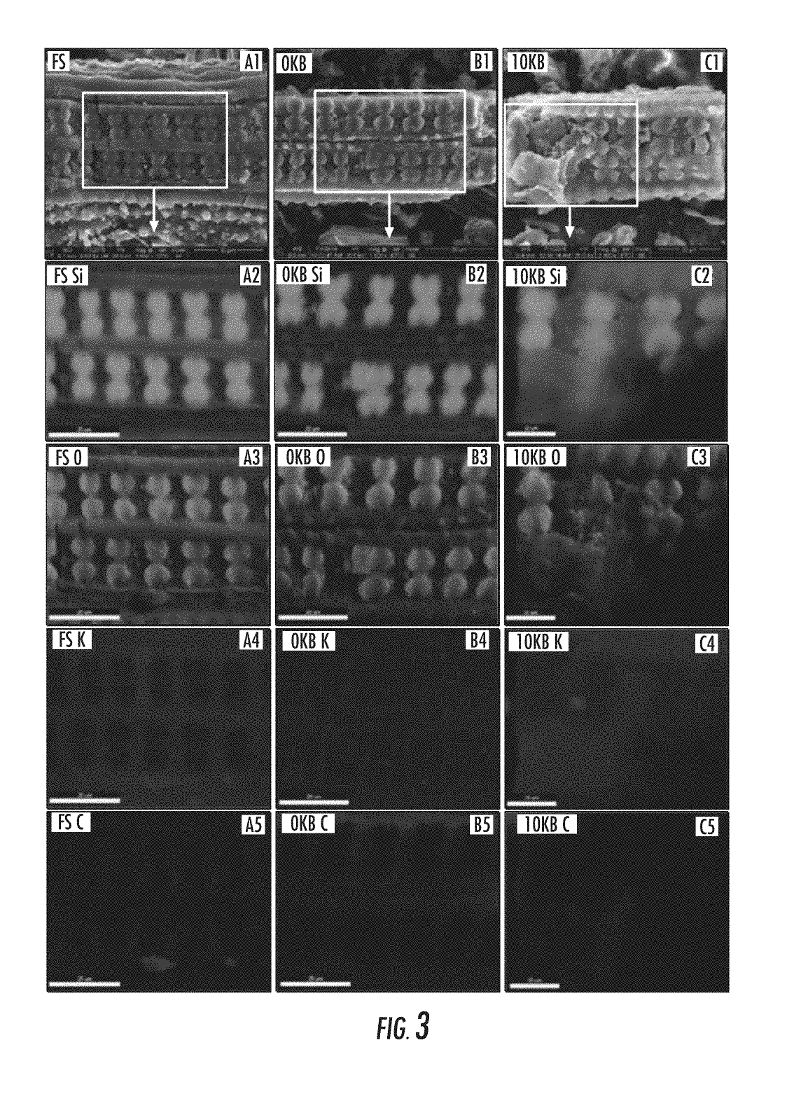

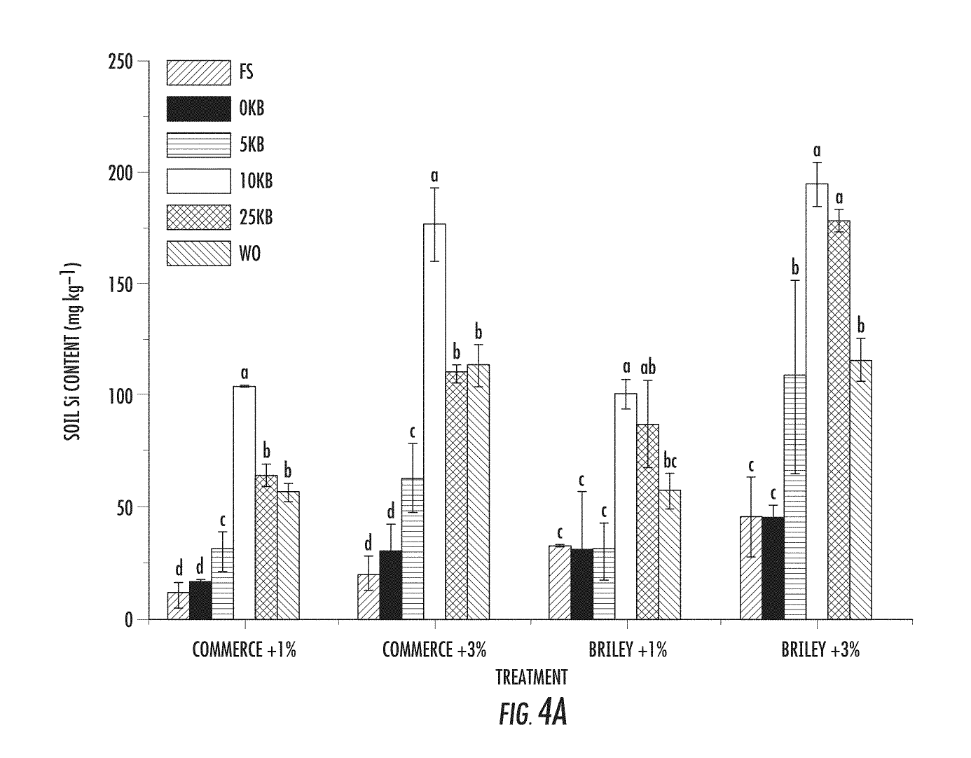

The KOH pretreatment increased soluble plant-available Si as determined by 5-day Na₂CO₃—NH₄NO₃ extraction and the degree of increase was different among different KOH-enhanced biochars as shown in FIGS. 2A-2D. While the 10 KB yielded the maximum amounts of soluble Si at 4.67% and 2.13%, respectively, for rice straw and miscanthus derived biochars, the 5 KB had the maximum soluble Si of 2.20% for sugarcane harvest residue biochar and the 1 KB gave the 0.85% for switchgrass-derived biochar. The change in the maximum amount of plant-available Si by Na₂CO₃—NH₄NO₃ extraction from rice straw and miscanthus-derived biochars at 10 KB to switchgrass biochar at 1 KB corresponded to the decreasing total Si content in the KOH-enhanced biochars, which was consistent with the total Si concentrations in the respective biomass materials as illustrated in FIGS. 1A-1D. As total Si in the feedstock was decreased, a less amount of KOH pretreatment would be required to access the maximum amount of available Si extractable. The greater amount of KOH pretreatment accounts for greater ash and K mass of the final biochar product would cause greater KOH pretreatment to extract the maximum available Si of the greater Si-rich feedstock materials. For the Si-rich rice straw, the KOH-enhanced soluble Si for 10 KB biochar was 222% more than the feedstock (FS) and 110% more than the 0 KB, the rice straw biochar without KOH pretreatment. In addition, the 4.67% soluble Si content observed with 10 KB rice straw biochar was approximately twice of 2.37% that found for wollastonite, a common solid source of Si fertilizer for soil application as illustrated in FIGS. 2A-D. The miscanthus and sugarcane harvest residue-produced biochars with KOH treatment had the maximum available Si similar to that of wollastonite, whereas switchgrass biochar yielded generally lower maximum soluble Si FIGS. 2A-D. Although Na₂CO₃—NH₄NO₃ extraction method has been considered favorable for measuring available Si of wollastonite as Si fertilizer (Haynes, R. J., Belyaeva, O. and Kingston, G., 2013. Evaluation of industrial wastes as sources of fertilizer silicon using chemical extractions and plant uptake. Journal of Plant Nutrition and Soil Science. 176, 238-248), these results indicate superior Si availability of KOH-enhanced rice straw biochar at 10 KB over the wollastonite, indicating the potential of 10 KB rice straw biochar as a solid source of Si fertilizer. It was also found that 10 KB rice straw biochar had more than 1.8 times of available Si than that often reported for silicate slag (around 2.5%) in the literature (Sebastian et al., 2013).

The generally higher soluble Si release in biochar produced from biomass contacted with KOH might be explained by Si solubility being pH-dependent (Fraysse, F., Pokrovsky, O. S., Schott, J., et al., 2006. Surface properties, solubility and dissolution kinetics of bamboo phytoliths. Geochimica et Cosmochimica Acta. 70, 1939-1951), thus increasing the availability of phytoliths-Si, as indicated by the morphological changes from rice straw feedstock to the converted 0 KB and KOH-enhanced 10 KB biochars as illustrated in FIG. 3.

As shown in FIG. 3, the morphology of phytoliths (i.e., dumbbell shape) was gradually broken from rice straw feedstock to 0 KB biochar with pyrolysis and further to 10 KB biochars produced by biomass contacted with KOH. In rice straw feedstock, the double arrangement of phytoliths was presented as an entire dumbbell shape as shown in FIG. 3-A1. As indicated by elemental mapping, as shown in FIGS. 3-A2, 3-A3, 3-A4 and 3-A5, silicon and oxygen were the main composition of phytoliths, and potassium and carbon were mainly located outside of phytoliths. For the 0 KB biochar sample which was produced under 550° C. pyrolysis temperature, most edges of phytoliths showed different degrees of crush and damage as shown in FIG. 3B. A close examination of SEM image (as shown in FIG. 3-B1) revealed that one phytolith dumbbell was seriously broken with a quarter of the area of phytolith attached to its neighboring phytolith dumbbell. The Si elemental mapping showed the clear variation of phytoliths in the 0 KB biochar sample as shown in FIG. 3-B2. The 10 KB biochar sample had even more dramatic changes in phytolith structure as shown in FIG. 3C. Since the arrangements of phytoliths were stacked in layers, KOH pretreatment had caused the outmost layers of phytoliths torn from top to bottom and exposed the lower layer of phytoliths. The elemental mapping also showed that the falling structure contained a large aggregation of Si as shown in FIG. 3-C2. These SEM observations along with Na₂CO₃—NH₄NO₃ extraction results demonstrated that KOH vigorously reacted with biomass at high pyrolysis temperature thereby causing the structure of plant phytoliths greatly destroyed, and therefore released more plant-available Si. Xiao et al. recently studied Si release from biochars made at pyrolysis temperature range of 150° C.-700° C. and found that 350° C. released the highest amount of dissolved Si and high temperatures (500° C.-700° C.) had lower dissolved Si release due to the increased formation of crystal Si (Xiao, X., Chen, B. and Zhu, L., 2014. Transformation, morphology, and dissolution of silicon and carbon in rice straw-derived biochars under different pyrolytic temperatures. Environmental science & technology. 48, 3411-3419). They explained that the damage of the mutual protection between carbon and Si led to carbon dissolution that would expose biochar Si for release (Xiao et al., 2014). On the other hand, the results of KOH enhancement also further demonstrated the significant release of plant-available Si from biochar through morphological and structural change of phytoliths even at 550° C. a pyrolysis temperature that can promote stable carbon formation as beneficial soil amendment as opposed to that at 350° C. (Jeong, C. Y., Dodla, S. K. and Wang, J. J., 2016. Fundamental and molecular composition characteristics of biochars produced from sugarcane and rice crop residues and byproducts. Chemosphere. 142, 4-13).

The significantly higher total Si content and much improved plant-available Si by KOH pretreatment in rice straw biochar as compared to the biochars derived from the other biomasses make it stand out as a KOH-enhanced biochar-based Si fertilizer source. Considering the economics of resource using KOH, which also contributes to the enhanced K nutrient in this Si-based fertilizer, the use of biochar produced from a biomass contacted with pretreatment agent, especially 10 KB biochar produced from biomass contacted with potassium hydroxide, can be used alternative biochar-based Si fertilizers. As much as 94.6% of K in the 10 KB rice straw biochar was found to be potentially available by Mehlich III extraction. This result indicates the advantage of employing KOH pretreatment to solubilize phytolith-Si with enhanced K nutrient of biochar-Si fertilizer.

### 5.3 Impact of Pretreated Biochar on Plant Available Silicon and pH of Soil.

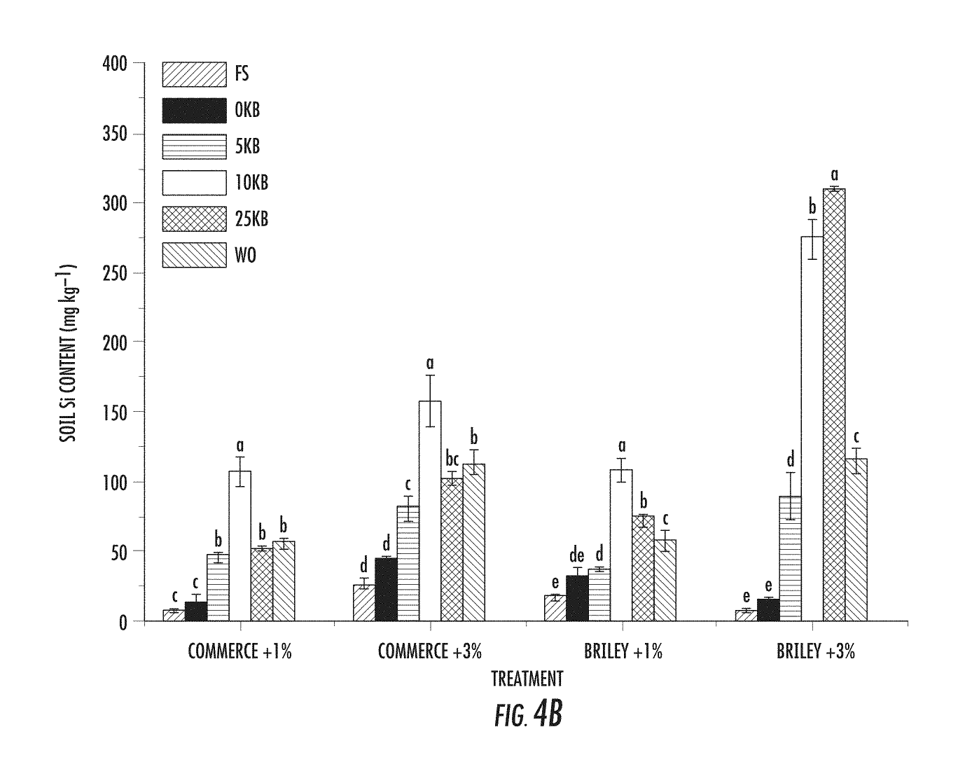

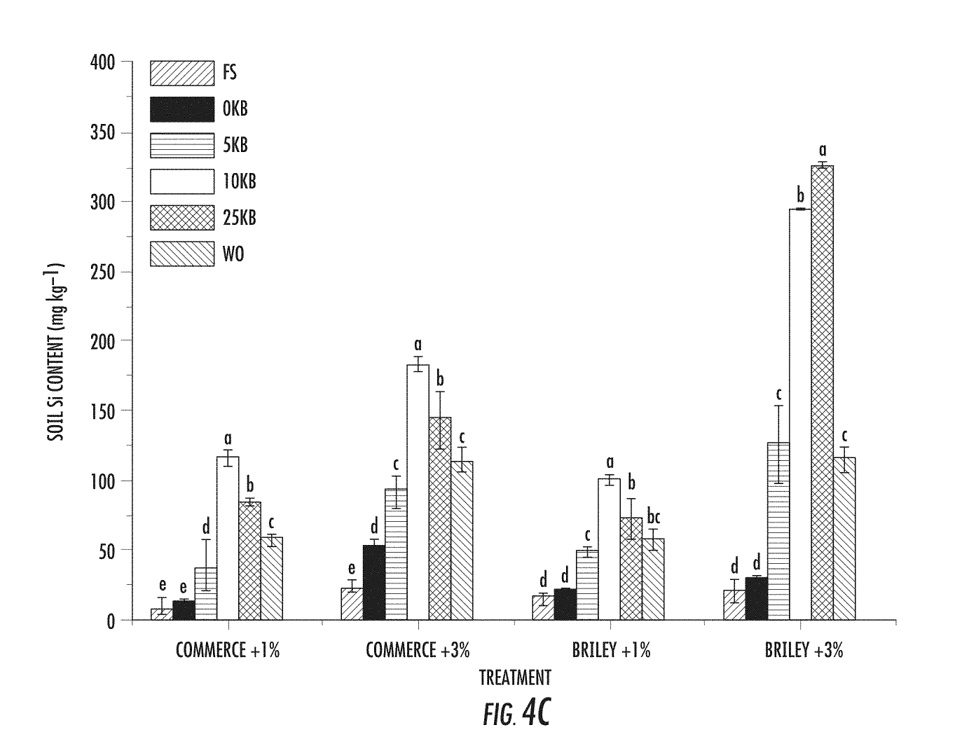

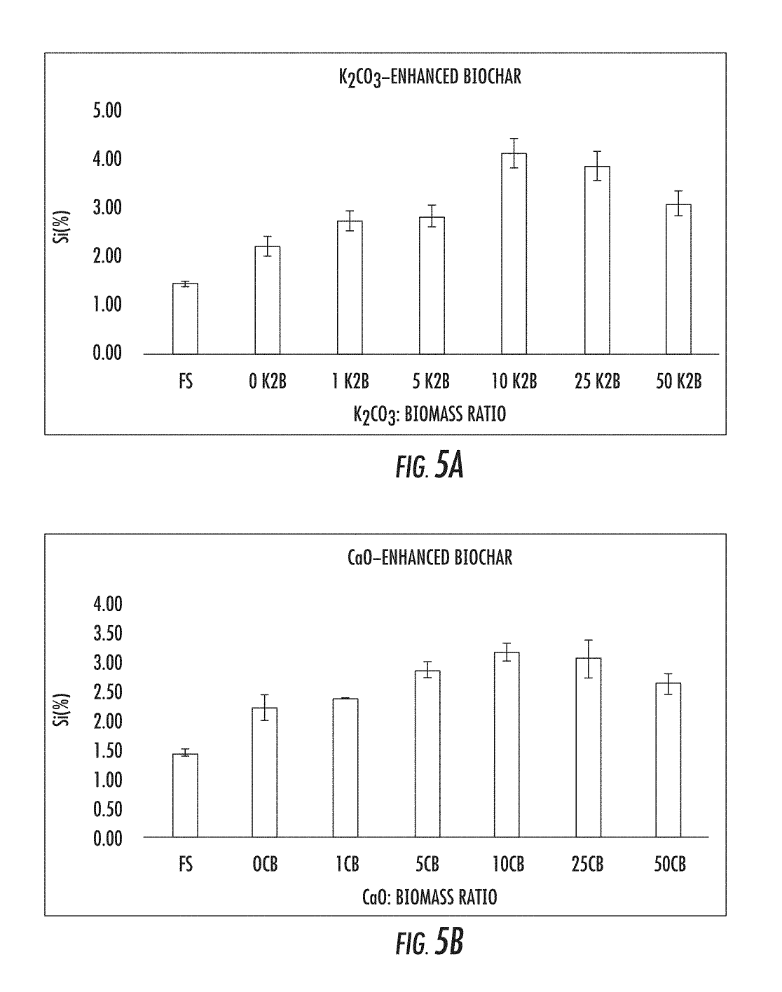

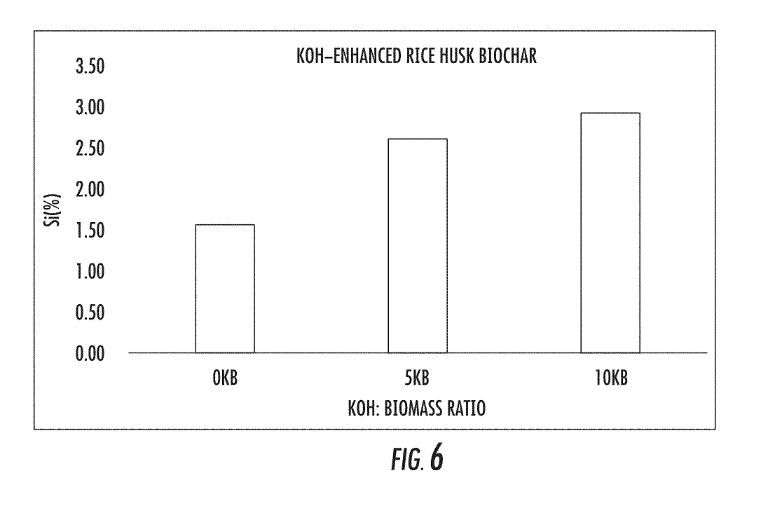

The performance effect of biochar produced from biomass pretreated with potassium hydroxide on plant-available Si in soil was evaluated by applying the biochars to two acid soils followed by incubation and determination of plant-available Si by sodium acetate extraction, a common method used for assessing soil bioavailable Si (Wang et al., 2004). For comparison purposes, the incubation was carried out with biomass material, 0 KB, 5 KB, 10 KB and 25 KB biochars of rice straw, miscanthus and sugarcane harvest residue along with standard Si fertilizer wollastonite and the results are shown in FIGS. 4A-4C. Immediately available Si was determined on the 8th day of incubation experiment because Si dissolution rate of fertilizer usually increases after an eight-day slow period (Xiao et al., 2014). The biomass application yielded the lowest plant-available Si in both Commerce and Briley soils, whereas biochar produced from biomass pretreated with potassium hydroxide exhibited significantly increased plant-available Si. At 1% soil application rate, on a weight basis, the 10 KB biochar yielded the highest plant available Si, a level that is significantly higher than that by the standard Si fertilizer wollastonite, followed by 25 KB, 5 KB and 0 KB biochars as shown in FIGS. 4A-4C. Interestingly, for soils amended with sugarcane harvest residue biochar, the 10 KB also exhibited the highest plant-available Si by sodium acetate extraction, even though the 5 KB had the maximum soluble Si by 5-day Na₂CO₃—NH₄NO₃ extraction as shown in FIGS. 2A-2D. This difference might be due to the nature of two methods as the sodium acetate solution tends to extract mobile or loosely bound or some fractions of amorphous forms of Si which belong to soluble Si (Savant, N. K., Korndorfer, G. H., Datnoff, L. E., et al., 1999. Silicon nutrition and sugarcane production: A review. Journal of Plant Nutrition. 22, 1853-1903.), whereas Na₂CO₃—NH₄NO₃ extraction emphasizes on the release of CaSiO₃-dominated sources (Haynes, R. J., Belyaeva, O. and Kingston, G., 2013. Evaluation of industrial wastes as sources of fertilizer silicon using chemical extractions and plant uptake. Journal of Plant Nutrition and Soil Science. 176, 238-248). As expected, biochar application rates at 3%, on a weight basis, generally yielded greater plant-available Si than those at 1% biochar application rate, on a weight basis.

Interestingly, in the Briley soil with 3% biochar application, the 10 KB and 25 KB biochars derived from miscanthus and sugarcane harvest residue yielded more plant-available Si content (274-324 mg kg⁻¹) than the rice straw 10 KB and 25 KB biochars (178-194 mg kg-1) and they were also much more than that of wollastonite treatment as shown in FIGS. 4A-4C. A close look at soil pH levels following the application of biochar materials indicated that the application of biochar produced from biomass prestreated with potassium hydroxide significantly increased soil pH especially at higher rates of biochar application as shown in Tables 2 and 3. For all cases, KOH pretreated rice straw-derived biochars had the lowest soil pH increases as compared to those of KOH treated miscanthus and sugarcane harvest residue-derived biochars, which were likely due to greater presence of Al and Fe in rice straw feedstock and biochars as shown in Table 1. The hydrolysis of Al and Fe often causes acidity (Sparks, D. and Bartels, J. 1996. Pt. 3: Chemical methods: Madison: Soil Science Society of America etc.), which could hinder the increase of pH during the incubation. For 10 KB and 25 KB rice straw biochar amendments, 1% and 3% application rates had 0.07-0.76 and 0.11-0.73 pH units lower in both Commerce and Briley soils than those amended with miscanthus and sugarcane harvest residue-derived 10 KB and 25 KB biochars, respectively, during the course of incubation. At the end of incubation for 3% application rate, the relative lower pH in Briley soil amended with 10 KB and 25 KB rice straw biochars than that amended with miscanthus and sugarcane harvest residue-derived 10 KB and 25 KB biochars (soil pH 7.92 vs. 8.48-8.52 for 10 KB application, and soil pH 9.21 vs. 9.66-9.76 for 25 KB application, respectively) likely contributed to the difference in plant-available Si as determined by sodium acetate extraction as shown in Table 3. Soil pH close to 9 and above can significantly solubilize soil mineral Si (Stumm, W., Morgan, J. J. and Dreyer, J. I., 1996. Aquatic chemistry. Journal of Environmental Quality. 25, 1162). The observed result also suggested that the significant increase of available Si for all 1% application was due to the addition of Si from KOH-enhanced rice straw biochar rather than the solubilization of Si from soil by alkalinity increase as the biochar amendment maintained soil pH generally <9.

It should be pointed out that the liming function of biochar has been proposed besides its positive impact on carbon sequestration since base cations, such as Ca, Mg, K and Na, in biomass are transformed, during pyrolysis, into oxides, hydroxides and carbonates (Van Zwieten, L., Kimber, S., Morris, S., et al., 2010. Effects of biochar from slow pyrolysis of papermill waste on agronomic performance and soil fertility. Plant and soil. 327, 235-246; Novak, J. M., Busscher, W. J., Laird, D. L., et al., 2009. Impact of biochar amendment on fertility of a southeastern coastal plain soil. Soil science. 174, 105-112). The dissolution of these alkaline substances makes most biochars as a liming agent when applied to soil (Hass, A., Gonzalez, J. M., Lima, I. M., et al., 2012. Chicken manure biochar as liming and nutrient source for acid Appalachian soil. Journal of Environmental Quality. 41, 1096-1106; Novak et al., 2009; Yuan, J. H., Xu, R. K. and Zhang, H., 2011. The forms of alkalis in the biochar produced from crop residues at different temperatures. Bioresource technology. 102, 3488-3497.). On the other hand, with additional treatment of KOH, the liming strength of these biochars could be greater. For both Commerce (pH 4.45) and Briley (pH 5.23) soils, at 1% application rate on a weight basis, 10 KB and 25 KB biochars yielded the most appropriate effects on the pH of these acidic soils (5.83-6.85 and 6.49-7.46, respectively) after 8 days of incubation as shown in Tables 2 and 3. At 3% application rate on a weight basis, 5 KB biochar improved the pH of acidic soils to an appropriate level (pH 6.91-7.57), whereas 25 KB biochar treatments increased soil pH to 8.46-9.76, which exceeded the suitable pH range for the growth of the most plants. Based on these results, it is expected that the 10 KB biochar especially derived from rice-straw at 1% or less rate of application could be recommended as an effective alternative Si fertilizer without jeopardizing soil reaction condition for plant growth.

### 5.4 Implication to Agroecosystem Sustainability.

Traditionally, terrestrial Si cycling and silica fluxes to soil solutions and stream waters have been assumed to be controlled mainly by weathering and subsequent dissolution of silicate minerals (Sommer, M., Kaczorek, D., Kuzyakov, Y., et al., 2006. Silicon pools and fluxes in soils and landscapes—a review. Journal of Plant Nutrition and Soil Science. 169, 310-329; Conley, D. J., 2002. Terrestrial ecosystems and the global biogeochemical silica cycle. Global Biogeochemical Cycles. 16). Yet, plants also take up considerable amounts of Si from soil solution released by weathering process, resulting in large quantities of Si stored as amorphous, biogenic silica in biomass and soils in the form of phytoliths (Deny, L. A., Kurtz, A. C., Ziegler, K., et al., 2005. Biological control of terrestrial silica cycling and export fluxes to watersheds. Nature. 433, 728-731.; Clymans, W., Struyf, E., Govers, G., et al., 2011. Anthropogenic impact on amorphous silica pools in temperate soils. Biogeosciences. 8, 2281-2293; Cornelis, J. T., Delvaux, B., Georg, R., et al., 2011. Tracing the origin of dissolved silicon transferred from various soil-plant systems towards rivers: a review. Biogeosciences. 8, 89-112.). The re-uptake of the dissolved Si by vegetation and its subsequently recycling into the soil from litter fall and plant decay constitute a separate soil-plant Si cycle that can be significant in comparison with weathering input and hydrologic output (Derry et al., 2005; Struyf, E., Smis, A., Van Damme, S., et al., 2009. The global biogeochemical silicon cycle. Silicon. 1, 207-213; Vandevenne, F., Struyf, E., Clymans, W., et al., 2012. Agricultural silica harvest: have humans created a new loop in the global silica cycle? Frontiers in Ecology and the Environment. 10, 243-248). On the other hand, human land use activities such as deforestation and agricultural harvest are increasingly recognized for potentially interrupting this recycle system (Meunier, J., Guntzer, F., Kirman, S., et al., 2008. Terrestrial plant-Si and environmental changes. Mineralogical magazine 72, 263-267; Clymans et al., 2011; Vandevenne et al., 2012). In agricultural ecosystems, soil biogenic Si pools become exhausted due to increased erosion as well as not being replenished by new biomass due to crop harvest and straw removal. As biogenic Si is generally much more bioavailable than soil mineral Si (Clymans et al., 2011), an effective supply of biogenic Si such as phytolith-Si is increasingly critical to sustainable agricultural crop production. This could be especially important for Si accumulating crops such as rice, sugarcane and wheat, since they can result in rapid depletion of soil phytolith pools (Datnoff, L. E., Snyder, G. H. and Korndorfer, G. H. 2001. Silicon in agriculture: Elsevier.). While Si fertilization could offset the harvest and leaching losses of Si from agricultural ecosystems, KOH-enhanced biochar made from agricultural crop residue with KOH pretreatment could release equivalent to or even more plant-available Si than some of currently used mineral Si fertilizer such as wollastonite. In addition, biochar produced from biomass pretreated with potassium hydroxide can be used as potash fertilizer to provide K nutrient.

Since biochar C is estimated to have long mean residence times (MRTs) in the range of potentially centuries to millennia (Johannes, L. and Stephen, J., 2009. Biochar for Environmental Management: An Introduction. Biochar for Environmental Management-Science and Technology, UK, Earthscan; Kuzyakov, Y., Subbotina, I., Chen, H., et al., 2009. Black carbon decomposition and incorporation into soil microbial biomass estimated by 14 C labeling. Soil Biology and Biochemistry. 41, 210-219; Zimmerman, A. R., 2010. Abiotic and microbial oxidation of laboratory-produced black carbon (biochar). Environmental science & technology. 44, 1295-1301.), soil application of biochar produced from biomass pretreated with potassium hydroxide could also benefit soil C sequestration. The biochar produced from biomass pretreated with potassium hydroxide could be considered as a win-win solution for improving the sustainability of agricultural ecosystems by providing multiple functions of disease control from Si, nutrition from K, and C sequestration.

TABLE 1
Chemical and physical properties of feedstocks and KOH-enhanced biochars from
rice straw, miscanthus, sugarcane harvest residue, and switchgrass^{†}

| | | | | | | | | | | | | |
|---|---|---|---|---|---|---|---|---|---|---|---|---|
| | | | | | | | P | K | Ca | Mg | Al | Fe |
| Materials | Yield % | pH | Ash % | C % | H % | N % | g kg⁻¹ | g kg⁻¹ | g kg⁻¹ | g kg⁻¹ | g kg⁻¹ | g kg⁻¹ |

Rice straw

| | | | | | | | | | | | | |
|---|---|---|---|---|---|---|---|---|---|---|---|---|
| FS | — | 6.19 | 17.00 | 38.82 | 4.04 | 1.12 | 0.90 | 11.72 | 1.90 | 1.75 | 0.28 | 0.16 |
| 0 KB | 35.34 | 9.59 | 45.12 | 45.03 | 1.269 | 2.19 | 1.84 | 16.09 | 4.45 | 3.15 | 0.45 | 0.30 |
| 1 KB | 36.71 | 9.86 | 48.48 | 43.44 | 1.145 | 1.71 | 1.87 | 26.54 | 4.72 | 3.23 | 0.48 | 0.32 |
| 5 KB | 37.14 | 10.22 | 52.69 | 41.26 | 0.94 | 1.23 | 1.80 | 86.02 | 4.47 | 3.09 | 0.51 | 0.32 |
| 10 KB | 39.00 | 10.51 | 57.93 | 34.21 | 0.75 | 1.00 | 1.75 | 138.46 | 4.39 | 3.09 | 0.46 | 0.31 |
| 25 KB | 44.35 | 10.78 | 69.33 | 26.80 | 0.528 | 0.68 | 1.38 | 254.98 | 3.56 | 2.39 | 0.30 | 0.24 |
| 50 KB | 53.21 | 10.86 | 82.05 | 20.15 | 0.358 | 0.62 | 1.10 | 378.33 | 2.86 | 1.91 | 0.24 | 0.20 |

Miscanthus

| | | | | | | | | | | | | |
|---|---|---|---|---|---|---|---|---|---|---|---|---|
| FS | — | 5.87 | 6.52 | 47.83 | 5.42 | 0.56 | 1.63 | 6.89 | 3.53 | 0.94 | 0.03 | 0.08 |
| 0 KB | 30.26 | 9.56 | 20.57 | 67.08 | 1.86 | 1.25 | 5.05 | 17.96 | 11.82 | 2.71 | 0.10 | 0.25 |
| 1 KB | 28.14 | 9.66 | 24.41 | 65.44 | 1.77 | 1.19 | 5.50 | 33.70 | 13.01 | 3.00 | 0.14 | 0.29 |
| 5 KB | 30.44 | 10.07 | 34.52 | 63.14 | 1.81 | 0.95 | 4.75 | 96.37 | 11.10 | 2.58 | 0.12 | 0.25 |
| 10 KB | 31.67 | 10.43 | 48.10 | 56.34 | 1.82 | 0.83 | 4.18 | 158.31 | 9.94 | 2.23 | 0.11 | 0.21 |
| 25 KB | 38.78 | 10.56 | 65.70 | 44.33 | 1.94 | 0.55 | 3.07 | 300.47 | 7.49 | 1.68 | 0.08 | 0.16 |
| 50 KB | 47.32 | 10.84 | 81.75 | 25.78 | 1.4 | 0.19 | 1.95 | 376.14 | 4.79 | 1.12 | 0.05 | 0.11 |

Sugarcane harvest residue

| | | | | | | | | | | | | |
|---|---|---|---|---|---|---|---|---|---|---|---|---|
| FS | — | 6.38 | 6.95 | 45.62 | 5.32 | 1.31 | 1.48 | 11.56 | 4.16 | 1.70 | 0.02 | 0.06 |
| 0 KB | 30.90 | 9.63 | 21.05 | 68.58 | 1.851 | 1.67 | 5.01 | 35.75 | 14.00 | 5.40 | 0.06 | 0.23 |
| 1 KB | 28.10 | 9.75 | 25.91 | 65.86 | 1.717 | 1.48 | 5.44 | 55.31 | 15.28 | 5.83 | 0.08 | 0.25 |
| 5 KB | 30.36 | 10.03 | 43.62 | 60.87 | 1.752 | 1.36 | 4.31 | 79.77 | 12.48 | 4.67 | 0.07 | 0.22 |
| 10 KB | 31.29 | 10.35 | 50.74 | 58.72 | 1.642 | 1.11 | 3.84 | 183.78 | 10.97 | 4.10 | 0.07 | 0.19 |
| 25 KB | 38.94 | 10.60 | 69.48 | 38.89 | 1.462 | 0.69 | 2.58 | 274.92 | 8.11 | 3.02 | 0.05 | 0.14 |
| 50 KB | 47.84 | 10.84 | 83.54 | 27.94 | 1.58 | 0.3 | 1.76 | 366.11 | 5.38 | 2.03 | 0.04 | 0.10 |

Switchgrass

| | | | | | | | | | | | | |
|---|---|---|---|---|---|---|---|---|---|---|---|---|
| FS | — | 4.48 | 2.07 | 45.20 | 5.35 | 0.89 | 0.66 | 4.57 | 1.86 | 1.29 | 0.04 | 0.05 |
| 0 KB | 29.08 | 9.52 | 9.48 | 80.75 | 2.14 | 0.65 | 2.02 | 13.31 | 7.00 | 4.33 | 0.15 | 0.19 |
| 1 KB | 27.86 | 9.61 | 15.00 | 79.55 | 1.88 | 0.67 | 1.98 | 24.99 | 7.17 | 4.21 | 0.72 | 0.21 |
| 5 KB | 29.58 | 9.94 | 28.95 | 71.32 | 1.9 | 0.53 | 1.65 | 126.41 | 5.67 | 3.40 | 0.43 | 0.16 |
| 10 KB | 31.58 | 10.32 | 39.66 | 64.17 | 1.59 | 0.42 | 1.54 | 180.73 | 5.10 | 3.04 | 0.62 | 0.15 |
| 25 KB | 37.41 | 10.64 | 62.66 | 47.22 | 1.77 | 0.35 | 1.30 | 322.29 | 4.24 | 2.54 | 0.30 | 0.13 |
| 50 KB | 48.37 | 11.02 | 78.10 | 33.29 | 1.53 | 0.27 | 0.76 | 354.74 | 2.47 | 1.44 | 0.26 | 0.10 |

^{†}All values are averages of two replicates. Biochar pH was measured based on 1:100 solid to solution ratio. Total P, K, Ca, Mg, Al and Fe were determined by digestion using mitric acid and H₂O₂ followed by ICP.OES analysis except for C, N, and H, which were determined by dry combustion. FS, feedstock, 0 KB, 1 KB . . . 50 KB indicate the biochars prepared at the proportion of KOH to feedstock of 0, 1 . . . 50.

TABLE 2
Dynamic Changes of Commerce Soil pH after Biochar Application

| Application Rate of Feedstock | | Materials | Day 0 | Day 2 | Day 4 | Day 8 |
|---|---|---|---|---|---|---|
| 1% | Rice Straw | FS | 4.63 ± 0.04 | 4.79 ± 0.13 | 5.11 ± 0.04 | 4.75 ± 0.19 |
| | | 0 KB | 4.83 ± 0.03 | 4.87 ± 0.04 | 5.06 ± 0.01 | 4.82 ± 0.01 |
| | | 5 KB | 5.34 ± 0.01 | 5.47 ± 0.03 | 5.66 ± 0.08 | 5.32 ± 0.07 |
| | | 10 KB | 5.88 ± 0.07 | 5.62 ± 0.01 | 5.81 ± 0 | 5.83 ± 0 |
| | | 25 KB | 6.58 ± 0.08 | 6.69 ± 0.08 | 6.84 ± 0.08 | 6.49 ± 0.18 |
| | Miscanthus | FS | 4.68 ± 0.05 | 4.77 ± 0.12 | 5.06 ± 0.02 | 4.75 ± 0.04 |
| | | 0 KB | 4.90 ± 0.04 | 4.99 ± 0.03 | 5.34 ± 0.04 | 4.10 ± 0.06 |
| | | 5 KB | 5.71 ± 0.14 | 5.88 ± 0.28 | 6.11 ± 0.13 | 5.69 ± 0.11 |
| | | 10 KB | 6.13 ± 0.14 | 6.09 ± 0.03 | 6.17 ± 0.08 | 6.31 ± 0.01 |
| | | 25 KB | 7.19 ± 0.11 | 7.15 ± 0.10 | 7.42 ± 0.04 | 7.24 ± 0.04 |
| | Sugarcane Harvest Residue | FS | 4.63 ± 0.06 | 4.71 ± 0.06 | 4.94 ± 0.08 | 4.69 ± 0.14 |
| | | 0 KB | 4.82 ± 0.01 | 4.95 ± 0.11 | 5.20 ± 0.01 | 4.82 ± 0.05 |
| | | 5 KB | 5.60 ± 0.27 | 5.76 ± 0.42 | 5.92 ± 0.25 | 5.76 ± 0.30 |
| | | 10 KB | 6.01 ± 0 | 6.11 ± 0.03 | 6.18 ± 0.01 | 6.28 ± 0.11 |
| | | 25 KB | 7.04 ± 0.16 | 7.17 ± 0.07 | 7.42 ± 0.06 | 7.25 ± 0.14 |
| 3% | Rice Straw | FS | 4.74 ± 0.17 | 4.83 ± 0.12 | 5.10 ± 0.02 | 4.89 ± 0.10 |
| | | 0 KB | 5.38 ± 0.05 | 5.37 ± 0.04 | 5.59 ± 0.03 | 5.29 ± 0.02 |
| | | 5 KB | 7.02 ± 0.16 | 6.80 ± 0.12 | 7.04 ± 0.10 | 7.09 ± 0.05 |
| | | 10 KB | 7.58 ± 0.01 | 7.68 ± 0.05 | 7.72 ± 0 | 7.72 ± 0.01 |
| | | 25 KB | 8.43 ± 0.16 | 8.49 ± 0.02 | 8.61 ± 0.01 | 8.46 ± 0.07 |
| | Miscanthus | FS | 4.73 ± 0.18 | 4.75 ± 0.04 | 5.04 ± 0.01 | 4.83 ± 0.01 |
| | | 0 KB | 5.37 ± 0 | 5.51 ± 0.01 | 5.80 ± 0.01 | 5.50 ± 0.06 |
| | | 5 KB | 6.79 ± 0.03 | 6.87 ± 0.01 | 7.19 ± 0.04 | 6.91 ± 0.08 |
| | | 10 KB | 7.95 ± 0.16 | 8.12 ± 0.01 | 8.19 ± 0.01 | 8.20 ± 0.08 |
| | | 25 KB | 9.13 ± 0.10 | 9.14 ± 0.05 | 9.23 ± 0.07 | 9.12 ± 0.05 |
| | Sugarcane Harvest Residue | FS | 4.63 ± 0.12 | 4.78 ± 0.09 | 4.98 ± 0.02 | 4.76 ± 0.06 |
| | | 0 KB | 5.48 ± 0.13 | 5.4 ± 0.08 | 5.67 ± 0.09 | 5.46 ± 0.09 |
| | | 5 KB | 7.39 ± 0.11 | 7.51 ± 0.42 | 7.49 ± 0.07 | 7.35 ± 0.03 |
| | | 10 KB | 7.79 ± 0.09 | 7.79 ± 0.28 | 8.04 ± 0.13 | 8.08 ± 0.09 |
| | | 25 KB | 9.10 ± 0.13 | 9.19 ± 0.04 | 9.22 ± 0.06 | 9.14 ± 0.01 |

FS, feedstock;
0 KB, 1 KB . . . 50 KB indicate the biochars prepared at the proportion of KOH to feedstock of 0, 1 . . . 50.

TABLE 3
Dynamic Changes of Briley Soil pH after Biochar Application

| Application Rate of Feedstock | | Materials | Day 0 | Day 2 | Day 4 | Day 8 |
|---|---|---|---|---|---|---|
| 1% | Rice Straw | FS | 5.21 ± 0.10 | 5.98 ± 0.13 | 6.18 ± 0.11 | 5.92 ± 0.11 |
| | | 0 KB | 5.61 ± 0.01 | 5.87 ± 0.01 | 6.08 ± 0.08 | 5.90 ± 0.02 |
| | | 5 KB | 5.94 ± 0.02 | 6.55 ± 0.20 | 6.56 ± 0.08 | 6.28 ± 0.17 |
| | | 10 KB | 6.59 ± 0.05 | 6.73 ± 0.11 | 6.83 ± 0.21 | 6.74 ± 0.21 |
| | | 25 KB | 7.00 ± 0.03 | 7.29 ± 0.01 | 7.33 ± 0.01 | 7.14 ± 0.01 |
| | Miscanthus | FS | 5.15 ± 0.02 | 5.97 ± 0.11 | 6.13 ± 0.06 | 5.79 ± 0.08 |
| | | 0 KB | 5.45 ± 0.08 | 6.05 ± 0.03 | 6.23 ± 0.05 | 5.96 ± 0.04 |
| | | 5 KB | 6.16 ± 0.01 | 6.51 ± 0.10 | 6.62 ± 0.06 | 6.43 ± 0.16 |
| | | 10 KB | 6.69 ± 0.02 | 6.80 ± 0.04 | 6.93 ± 0.01 | 6.84 ± 0.05 |
| | | 25 KB | 7.43 ± 0.01 | 7.56 ± 0.01 | 7.62 ± 0.01 | 7.42 ± 0.02 |
| | Sugarcane Harvest Residue | FS | 5.21 ± 0.01 | 6.03 ± 0.11 | 6.17 ± 0.13 | 5.86 ± 0.23 |
| | | 0 KB | 5.42 ± 0.01 | 6.03 ± 0.01 | 6.15 ± 0.01 | 5.93 ± 0.04 |
| | | 5 KB | 6.27 ± 0.17 | 6.67 ± 0.16 | 6.75 ± 0.12 | 6.57 ± 0.13 |
| | | 10 KB | 6.66 ± 0 | 6.96 ± 0.01 | 6.95 ± 0.06 | 6.85 ± 0.02 |
| | | 25 KB | 7.35 ± 0.09 | 7.61 ± 0.01 | 7.57 ± 0.08 | 7.46 ± 0.08 |
| 3% | Rice Straw | FS | 5.24 ± 0.06 | 5.90 ± 0.06 | 6.15 ± 0.07 | 5.74 ± 0.04 |
| | | 0 KB | 5.84 ± 0.01 | 6.28 ± 0.07 | 6.36 ± 0.08 | 6.20 ± 0.13 |
| | | 5 KB | 7.52 ± 0.01 | 7.53 ± 0.06 | 7.4 ± 0.06 | 7.30 ± 0.05 |
| | | 10 KB | 8.06 ± 0.06 | 8.12 ± 0.14 | 8.13 ± 0.14 | 7.92 ± 0.19 |
| | | 25 KB | 9.18 ± 0.09 | 9.25 ± 0.12 | 9.22 ± 0.06 | 9.21 ± 0.08 |
| | Miscanthus | FS | 5.17 ± 0.04 | 5.79 ± 0.05 | 6.06 ± 0.10 | 5.74 ± 0.10 |
| | | 0 KB | 5.83 ± 0.04 | 6.28 ± 0.02 | 6.44 ± 0.08 | 6.29 ± 0.06 |
| | | 5 KB | 7.59 ± 0.06 | 7.75 ± 0.01 | 7.66 ± 0.04 | 7.57 ± 0.16 |
| | | 10 KB | 8.57 ± 0.03 | 8.85 ± 0.04 | 8.54 ± 0.01 | 8.48 ± 0.01 |
| | | 25 KB | 9.64 ± 0.01 | 9.58 ± 0.05 | 9.72 ± 0.01 | 9.76 ± 0.03 |
| | Sugarcane Harvest Residue | FS | 5.12 ± 0.01 | 5.84 ± 0.10 | 6.03 ± 0.21 | 5.84 ± 0.16 |
| | | 0 KB | 5.83 ± 0.05 | 6.32 ± 0.08 | 6.38 ± 0.04 | 6.23 ± 0.11 |
| | | 5 KB | 7.38 ± 0.17 | 7.54 ± 0.14 | 7.46 ± 0.16 | 7.29 ± 0.19 |
| | | 10 KB | 8.49 ± 0.04 | 8.60 ± 0.08 | 8.62 ± 0.21 | 8.52 ± 0.14 |
| | | 25 KB | 9.54 ± 0.01 | 9.64 ± 0.03 | 9.67 ± 0.03 | 9.66 ± 0.08 |

FS, feedstock;
0 KB, 1 KB . . . 50 KB indicate the biochars prepared at the proportion of KOH to feedstock of 0, 1 . . . 50.

The results indicated that pretreatment of biomass with a pretreatment agent described herein significantly increased plant-available silicon in formed biochar. Despite total Si concentrations less than 0 KB, 10 KB biochar, especially that made from rice straw resulted in the highest amount of plant-available Si release, which was due to the morphology and structural change of phytoliths caused by the interaction between pyrolysis temperature and alkaline reagent (KOH). In addition, the KOH pretreatment of biomasses not only enhanced K nutrient and liming potential of biochar product but also increased the C preservation of biomasses during the pyrolysis process, potentially improved soil C sequestration. Overall, biochar produced from biomass pretreated with potassium hydroxide, especially 10 KB, demonstrated clear potential to be used as an alternative source of Si fertilizer for plants. It also has significant implication in improving production sustainability of Si-accumulating crops.

It should be recognized that unless stated otherwise, it is intended that endpoints are to be interchangeable. Further, any ranges include iterative ranges of like magnitude falling within the expressly stated ranges or limitations disclosed herein is to be understood to set forth every number and range encompassed within the broader range of values. It is to be noted that the terms “range” and “ranging” as used herein generally refer to a value within a specified range and encompasses all values within that entire specified range.

Except as may be expressly otherwise indicated, the article “a” or “an” if and as used herein is not intended to limit, and should not be construed as limiting, a claim to a single element to which the article refers. Rather, the article “a” or “an” if and as used herein is intended to cover one or more such elements, unless the text taken in context clearly indicates otherwise.

Each and every patent or other publication or published document referred to in any portion of this specification is incorporated as a whole into this disclosure by reference, as if fully set forth herein.

This invention is susceptible to considerable variation in its practice. The particular illustrative examples which are described with particularity in this specification are not intended to limit the scope of the invention. Rather, the examples are intended as concrete illustrations of various features and advantages of the invention, and should not be construed as an exhaustive compilation of each and every possible permutation or combination of materials, components, configurations or steps one might contemplate, having the benefit of this disclosure. Similarly, in the interest of clarity, not all features of an actual implementation of an apparatus, system or related methods of use are described in this specification. It of course will be appreciated that in the development of such an actual implementation, numerous implementation-specific decisions must be made to achieve the developers' specific goals, such as compliance with system-related and economic-related constraints, which may vary from one implementation to another. Moreover, it will be appreciated that while such a development effort might be complex and time-consuming, it would nevertheless be a routine undertaking for those of ordinary skill in the art having the benefit of this disclosure. Therefore, the foregoing description is not intended to limit, and should not be construed as limiting, the invention to the particular exemplifications presented hereinabove.

What is claimed is:

1. A method comprising:
contacting a biomass with a pretreatment agent comprising an alkali metal or an alkaline earth metal to form a pretreated biomass; and
pyrolyzing the pretreated biomass under conditions sufficient to form a biochar.

2. The method of claim 1 wherein the pretreatment agent to biomass ratio is from 1:100 to 50:100, on a weight basis.

3. The method of claim 1 wherein the pretreatment agent to biomass ratio is 10:100.

4. The method of claim 1 wherein the pyrolyzing step is carried out at a temperature in the range of about 350° C. to about 600° C.

5. The method of claim 1 further comprising dehydrating the pretreated biomass prior to the pyrolyzing step.

6. The method of claim 5 wherein the dehydrating step is carried out at a temperature in the range of about 150° C. to about 180° C.

7. The method of claim 1 wherein the pretreatment agent comprises at least one selected from the group consisting of potassium, calcium, and any combination thereof.

8. The method of claim 1 wherein the pretreatment agent comprises at least one selected form the group consisting of potassium hydroxide, potassium carbonate, and any combination thereof.

9. The method of claim 1 wherein the pretreatment agent comprises calcium oxide.

10. The method of claim 1 wherein the biomass comprises one or more materials selected from the group consisting of rice straw, rice husk, sugar cane harvest residue, miscanthus, and switch grass.

11. The method of claim 2 wherein the biomass comprises at least one selected from the group consisting of rice straw, rice husk, and any combination thereof.

12. The method of claim 11 wherein the pretreatment agent comprises calcium oxide.

13. The method of claim 12 wherein the pretreatment agent comprises at least one selected from the group consisting of potassium hydroxide, potassium carbonate, and any combination thereof.

14. A composition comprising a biochar having at least the following characteristics:
a pH in the range of about 8 to about 11, based on 1:100 biochar to deionized water ratio;
a total potassium content in the range of about 13.31 g/kg to about 378.33 g/kg, as measured by inductively coupled emission spectrometry; and
a soluble plant available silicon content in the range of about 0.75 wt. % to about 6.0 wt. % or greater, based on total weight of the composition containing biochar, wherein the soluble plant available silicon content is determined by 5-day Na₂CO₃—NH₄NO₃ extraction.

15. A composition comprising a biochar having at least the following characteristics:
a pH in the range of about 9.5 to about 10.5, based on 1:100 biochar to deionized water ratio;
a total potassium content in the range of about 79.77 g/kg to about 183.78 g/kg, as measured by inductively coupled emission spectrometry; and
a soluble plant available silicon content in the range of about 0.75% to about 6.0 wt. % or greater, based on total weight of the composition containing biochar, wherein the soluble plant available silicon content is determined by 5-day Na₂CO₃—NH₄NO₃ extraction.

16. A method comprising:
contacting soil with the composition according to claim 14 thereby increasing a soluble plant available silicon content in the soil.

17. A composition comprising a biochar prepared by the method according to claim 1.
